(19) United States
(12) Patent Application Publication
(10) Pub. No.: US 2008/0299356 A1
(43) Pub. Date: Dec. 4, 2008

(54) PLATED SUBSTRATE AND ITS FABRICATION METHOD

(75) Inventors: Toshihiko KANEDA, Hakusan (JP); Satoshi KIMURA, Fujimi (JP); Hidemichi FURIHATA, Chino (JP); Takeshi KIJIMA, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/866,038

(22) Filed: Oct. 2, 2007

(30) Foreign Application Priority Data
Oct. 3, 2006 (JP) 2006-271806

(51) Int. Cl. B32B 7/14; B05D 1/36

(52) U.S. Cl. 428/201; 427/258

(57) ABSTRACT

A plated substrate includes a substrate, a resin formed body having a specified pattern including catalytic metal that functions as a catalyst for electroless plating, and a metal layer formed on a top surface of the resin layer.

The entire disclosure of Japanese Patent Application No. 2006-271806, filed Oct. 3, 2006 is expressly incorporated by reference herein.

### BACKGROUND

1. Technical Field

The present invention relates to plated substrates and methods for fabricating the same.

2. Related Art

When forming metal wirings or the like on a substrate, for example, a subtractive method may be used. According to the subtractive method, a metal layer is formed over the entire surface of a substrate, photoresist is coated and patterned on the metal layer, and the metal layer is etched using the photoresist as a mask. Such a method entails a problem in that the resource and material may be wasted because the photoresist has to be eventually removed and portions of the metal layer need to be removed. Japanese Laid-open Patent Application JP-A-10-65315 is an example of related art.

### SUMMARY

In accordance with an advantage of some aspects of the present invention, it is possible to provide a plated substrate and its fabrication method in which fine patterns can be accurately formed with a relatively simple process.

A plated substrate in accordance with an embodiment of the invention includes a substrate, a resin formed body having a specified pattern including catalytic metal that functions as a catalyst for electroless plating, and a metal layer formed on a top surface of the resin layer.

In the plated substrate in accordance with an aspect of the invention, the metal layer may be formed on a top surface and a side surface of the resin formed body, and the metal layer formed on the top surface of the resin formed body may have a film thickness greater than a film thickness of the metal layer formed on the side surface of the resin formed body.

In the plated substrate in accordance with an aspect of the invention, the resin formed body may be composed of photoresist.

In the plated substrate in accordance with an aspect of the invention, the substrate may be a transparent substrate that transmits light with a predetermined wavelength.

A method for fabricating a plated substrate in accordance with an embodiment of the invention includes the steps of: (a) forming on a substrate a resin formed body having a specified pattern including catalytic metal that functions as a catalyst for electroless plating; and (b) forming a metal layer by dipping the substrate in an electroless plating liquid to precipitate metal on the resin formed body.

According to the method for fabricating a plated substrate in accordance with the invention, a metal layer can be formed without removing the resin formed body, such that wastes of the resources can be suppressed. Also, a metal layer in a shape that conforms to the shape of the resin formed body can be formed, such that a metal layer with minute patterns can be accurately formed with a relatively simple process.

In the method for fabricating a plated substrate in accordance with an aspect of the invention, the step (a) may include the steps of coating a resin material in a flow condition containing the catalytic metal on the substrate, pressing a nanostamper having a recessed pattern with a predetermined pattern to the substrate thereby transferring the predetermined pattern to the resin material, and hardening the resin material.

In the method for fabricating a plated substrate in accordance with an aspect of the invention, between the step (a) and the step (b), an upper portion of the hardened resin material and a portion of the resin material in a region other than the predetermined pattern may be removed by ashing.

In the method for fabricating a plated substrate in accordance with an aspect of the invention, the resin formed body may be composed of photoresist, and the resin formed body may be formed by an interference exposure method in the step (a).

### BRIEF DESCRIPTION OF THE DRAWINGS

FIG. 1 is a view showing a step of a method for fabricating a plated substrate in accordance with an embodiment of the invention.

FIG. 2 is a view showing a step of the method for fabricating a plated substrate in accordance with the embodiment of the invention.

FIG. 3 is a view showing a step of the method for fabricating a plated substrate in accordance with the embodiment of the invention.

FIG. 4 is a view showing a step of the method for fabricating a plated substrate in accordance with the embodiment of the invention.

FIG. 5 is a view showing a step of the method for fabricating a plated substrate in accordance with the embodiment of the invention.

FIG. 6 is a view showing a step of the method for fabricating a plated substrate in accordance with the embodiment of the invention.

FIG. 7 is a view showing a step of the method for fabricating a plated substrate in accordance with the embodiment of the invention.

FIG. 8 is a cross-sectional view of a plated substrate in accordance with an embodiment of the invention.

FIG. 9 is a perspective view of a plated substrate in accordance with an embodiment of the invention.

FIG. 10 shows a perspective view of an example of an electronic device using a plated substrate in accordance with an embodiment of the invention.

### DESCRIPTION OF EXEMPLARY EMBODIMENTS

Preferred embodiments of the invention are described below with reference to the accompanying drawings.

1. Method for Fabricating Plated Substrate

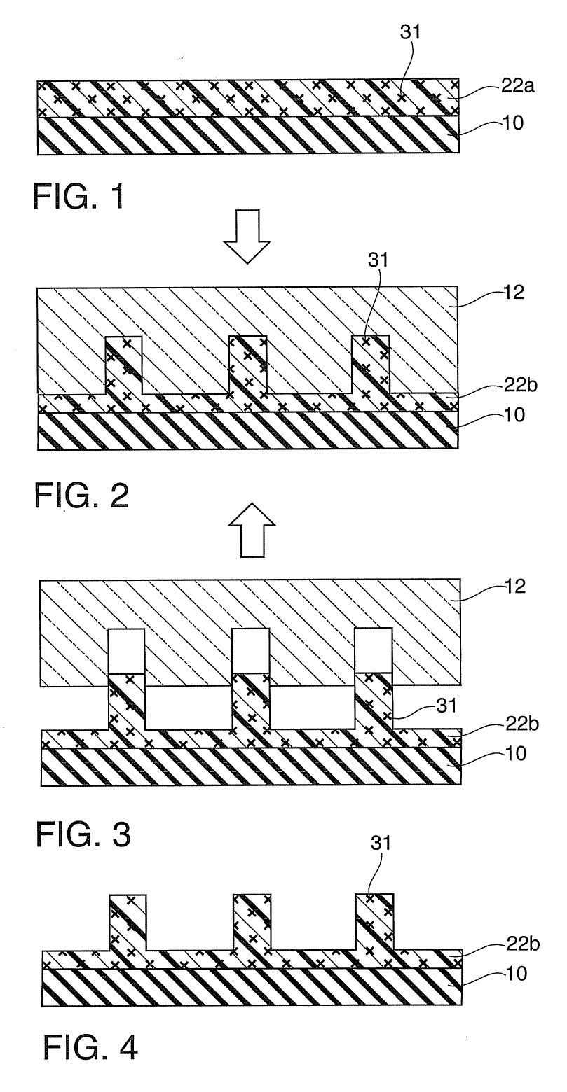

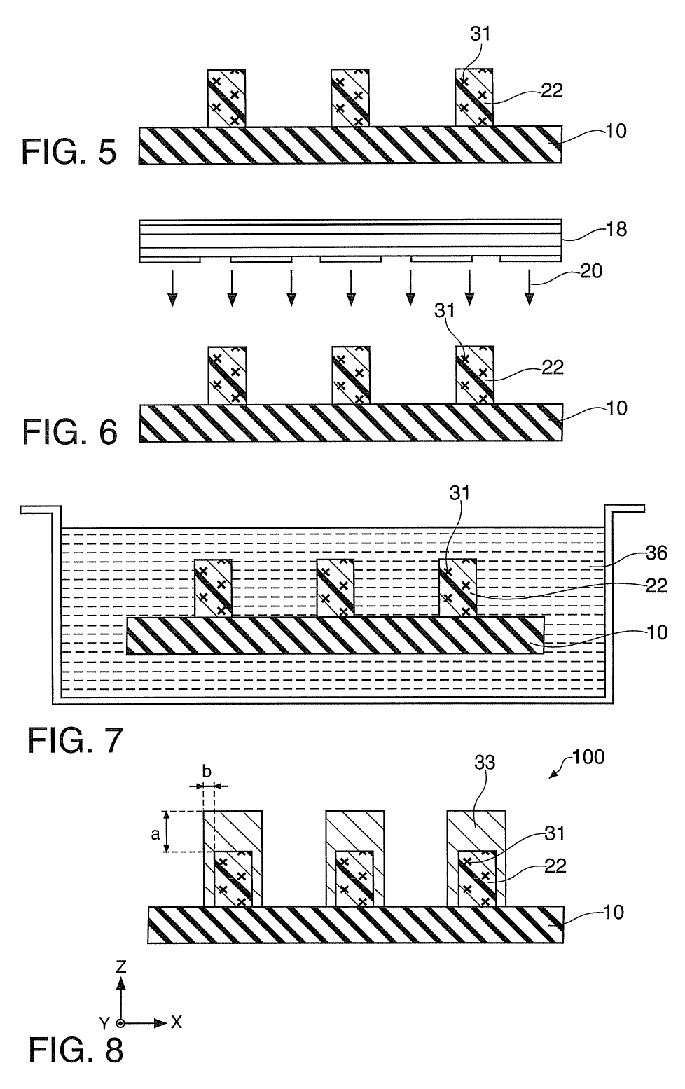

FIGS. 1-7 are views showing a method for fabricating a plated substrate 100 (see FIG. 8) in accordance with an embodiment of the invention. In the present embodiment, the plated substrate is fabricated by using electroless plating.

(1) First, a substrate 10 is prepared. The substrate 10 may be a dielectric substrate, as indicated in FIG. 1. A wiring substrate can be fabricated by forming a metal layer on the dielectric substrate by the steps to be described below. Alternatively, the substrate 10 may be composed of a light transmissive substrate that transmits visible light (for example, a transparent substrate). By forming a metal layer on the light transmissive substrate through the steps to be described below, an optical element, such as, for example, a polarizing plate, a phase difference film and the like.

Also, the substrate 10 may be formed from an organic system substrate (for example, a plastic material substrate or a resin substrate), or an inorganic system substrate (for example, a silica glass plate, a silicon wafer or oxide layer). As the plastic material, polyimide, polyethylene terephthalate, polycarbonate, polyphenylene sulfide, polyethylene naphthalate and the like can be enumerated. The substrate 10 may be in a single layer, or in a multilayer in which at least one dielectric layer is formed on a base substrate. In the present embodiment, a metal layer is formed on the substrate 10. No roughness may preferably be present on the surface of the substrate 10, and for example, the roughness, if any, may preferably be less than 10 nm in height.

Then, a resin formed body 22 having a predetermined pattern is formed on the substrate 10. The resin formed body 22 contains catalytic metal 31 that functions as a catalyst for electroless plating. As the catalytic metal 31, for example, palladium may be used. The resin formed body 22 may be made by a known method, for example, an interference exposure method, and a nanoimprint technique. In the present embodiment, the resin formed body 22 is formed by a nanoimprint technique as described below.

First, as shown in FIG. 1, a resin material 22a in a flow state is coated on the substrate 10. As the resin contained in the resin material 22a, thermosetting resin, thermoplastic resin, or photocurable resin can be used. Also, as the resin, for example, photoresist can be used. The resin material 22a may be obtained by, for example, contacting catalyst solution containing the catalytic metal 31 with the resin described above. The catalytic metal 31 may preferably be dispersed as fine particles in the resin material 22a.

For example, the catalyst solution can be made according to the following process.

First, 99.99% pure palladium pellets are dissolved in a mixed solution of hydrochloric acid, hydrogen peroxide water and water to prepare a palladium chloride solution with a palladium concentration of 0.1-0.5 g/l.

Then, the palladium chloride solution is further diluted with water and hydrogen peroxide water to prepare a solution with a palladium concentration of 0.01-0.05 g/l.

Next, by using a sodium hydroxide solution or the like, the palladium chloride solution is adjusted to have pH at 4.5-6.8. By the steps described above, the catalyst solution is prepared. Further, the prepared catalyst solution, a settable resin (a photosettable resin in this example), and an accelerating agent are mixed together.

As the coating method, a known method, such as, a spin coat method, a dip coat method, or an inkjet method may be used.

Then, a nanostamper 12 is pressed in a direction of the substrate 10 (in a direction indicated by an arrow in FIG. 2), thereby transferring a predetermined pattern to the resin material. The predetermined pattern may be composed of a periodical pattern of multiple lines disposed at constant intervals. When the resin material 22a is composed of a photosettable resin, the nanostamper 12 may be light transmissive.

Then, the resin formed body 22b is hardened, and the nanostamper 12 is peeled off the resin formed body 22b (see FIG. 3). In this manner, the resin formed body 22b having the predetermined pattern can be formed, as shown in FIG. 4.

With the resin formed body 22b, the step (2) to be described below may be conducted. However, the portion of the resin formed body 22b in gaps between the predetermined patterns may be removed by etch back. When the resin formed body 22b is composed of photoresist, portions thereof may be removed by ashing. In this case, upper portions of the resin formed body 22b in the area of the predetermined pattern, as well as portions of the resin formed body 22b in the gaps of the predetermined pattern are removed. By conducting this removal step, the resin formed body 22 can be formed. Also, after ashing, the substrate 10 may preferably be washed. As a result, portions of the catalytic metal 31 remaining on the substrate can be removed.

The resin formed body 22 can be made by using the nanoimprint technique in a manner described above. However, the resin formed body 22 may also be made by using the interference exposure method as described above. When the interference exposure method is used, photoresist is used as the resin material 22a, and a reflection prevention film may preferably be formed on the substrate 10 in advance.

(2) Next, the substrate 10 is washed. The substrate 10 may be washed by dry washing or wet washing, and may preferably be washed by dry washing. By dry washing, damage on the resin formed body 22, such as, exfoliation and the like can be prevented.

Dry washing may be conducted by irradiating vacuum ultraviolet light 20, using a vacuum ultraviolet lamp (with a wavelength of 172 nm, an output of 10 mW and a lamp-to-target distance of 1 mm) 18, in a nitrogen atmosphere for 30 seconds-900 seconds. By washing the substrate 10, dirt such as fats and oils adhered to the surface of the substrate 10 can be removed. Also, the surface property of the substrate 10 and the resin formed body 22 can be changed from water-repelling to hydrophilic. Furthermore, when the submerged surface potential of the substrate, 10 is at a negative potential, washing the substrate 10 can form a uniform negative potential surface thereon.

Wet washing may be conducted by, for example, dipping the substrate 10 in ozone water (with an ozone concentration of 10 ppm-20 ppm) at room temperature for about 5-30 minutes.

(3) Next, a metal layer 33 is formed on the substrate 10. Concretely, the metal layer 33 is formed in areas where the resin formed body 22 is formed. More specifically, as shown in FIG. 7, the substrate 10 is dipped in an electroless plating liquid 36 containing metal, whereby the metal layer 33 can be precipitated.

The metal may be, for example, nickel. The electroless plating liquid 36 may be a type used in an acidic state or a type used in an alkaline state. For example, a type used in an acidic state may be used as the electroless plating liquid 36. The electroless plating liquid 36 contains the above-described metal, a reducing agent and a complexing agent. Concretely, the electroless plating liquid 36 may be composed of nickel sulfate hexahydrate or nickel chloride hexahydrate as a main composition and sodium hypophosphite as a reducing agent. For example, by dipping the substrate 10 in the electroless plating liquid containing nickel sulfate hexahydrate (at 70° C.-80° C.) for about 10 seconds-about 10 minutes, a nickel layer having a thickness of 20 nm-100 nm can be formed.

In this manner, as shown in FIG. 8, the metal layer 33 can be formed on the top surface of the resin formed body 22 on the substrate 10.

After being dipped in the electroless plating liquid, the substrate 10 may be washed with water. Washing with water may be conducted with pure water, steam, or pure water and steam. After washing, a heat treatment may be applied to the substrate 10 for drying. As a result, adhesion of the metal layer 33 to the substrate 10 can be improved.

By the process described above, the plated substrate 100 can be formed, as shown in FIG. 8. The metal layer 33 of the plated substrate 100 is formed above and on the side surface of the resin formed body 22. The resin formed body 22 can function as a core of the metal layer 33.

According to the method for fabricating the plated substrate 100 in accordance with the present embodiment, the film thickness a of the metal layer 33 above the resin formed body 22 can be made greater than the film thickness b of the metal layer 33 on the side surface of the resin formed body 22. More concretely, the following is assumed to occur.

According to the method for fabricating the plated substrate 100 in accordance with the present embodiment, the substrate 10 is dipped in the electroless plating liquid 36, thereby precipitating the metal layer 33. The metal layer 33 is formed by an electroless plating reaction. The electroless plating reaction is a reducing reaction between the reducing agent and metal ions in the electroless plating liquid, in other words, a reaction in which the metal ions receive electrons from the reducing agent thereby precipitating plating particles. This reaction is accelerated by the catalytic metal 31 contained in the resin formed body 22, and therefore advances mainly in the proximity of the resin formed body 22. In the electroless plating liquid, plural metal ions are present in aggregates, and therefore plating particles that are aggregates of plural metal atoms precipitate as a result of the reducing reaction. It is noted that the size of each aggregate of plural metal ions may be controlled by pH, temperature, time and the like of the electroless plating liquid.

According to the present embodiment, plating particles within the electroless plating liquid 36 enters into gaps in the resin formed body 22, whereby the metal layer 33 can also be precipitated in the gaps of the resin formed body 22, in other words, on the side surfaces of the resin formed body 22. The electroless plating liquid 36 existing above the resin formed body 22 has a greater flowability compared with that of the electroless plating liquid 36 entered the gaps of the resin formed body 22. Accordingly, even when the metal ions are used for precipitation, the electroless plating liquid 36 near the upper surface of the resin formed body 22 has abundant fluidity, and therefore the concentration of the metal ions can generally stay at constant. In contrast, the electroless plating liquid 36 in the gaps of the resin formed body 22 temporarily has a lower concentration of metal ions after the metal ions precipitated as the metal layer 33, such that the precipitation rate of the metal layer 33 becomes lower. Therefore, according to the method for fabricating the plated substrate 100 in accordance with the present embodiment, the film thickness a of the metal layer 33 above the resin formed body 22 can be made greater than the film thickness b of the metal layer 33 on the side surface of the resin formed body 22.

2. Plated Substrate

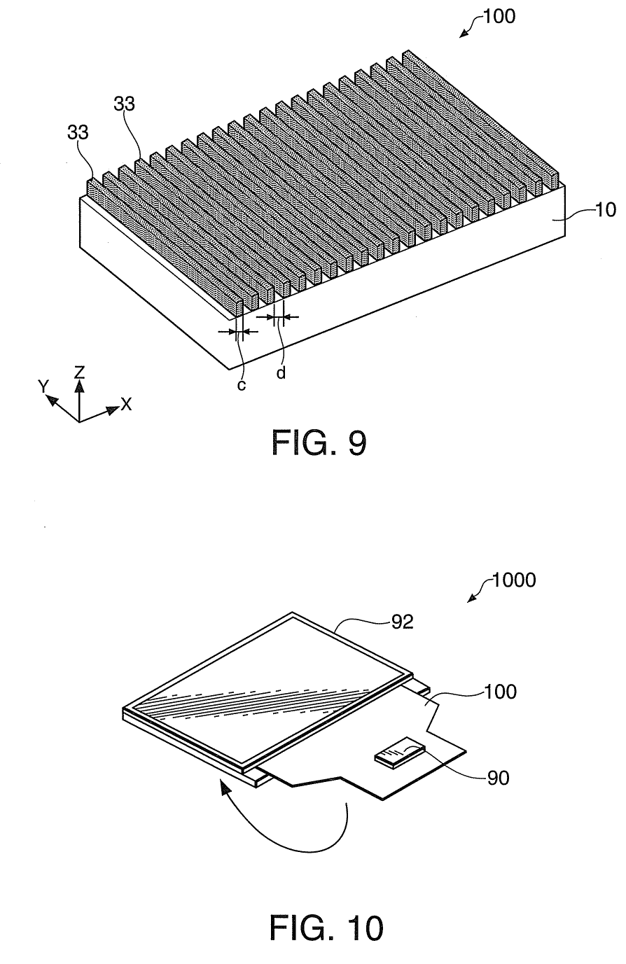

A plated substrate 100 fabricated by the method described above is described with reference to FIG. 9. FIG. 9 is a schematic perspective view of the plated substrate 100 in accordance with the present embodiment. The plated substrate 100 includes a substrate 10 and a metal layer 33 formed on the substrate 10. The metal layer 33 has a predetermined pattern. The predetermined pattern may be, for example, a one-dimensional or two-dimensional periodical pattern. A resin formed body 22 is provided inside the metal layer 33 in a pattern similar to that of the metal layer 33. The plated substrate 100, when formed from an optically transmissive substrate and a predetermined pattern provided thereon, can function as an optical element substrate such as a polarizing plate. For example, as shown in FIG. 9, the plated substrate 100 may have a one-dimensional periodical pattern (in stripes) in which linear metal layers each having a constant width c, spaced a constant gap d, are repeatedly provided in an X-axis direction. When the width c in the periodic direction (X-axis direction) is less, than the wavelength of visible light, and the substrate 10 is formed from an optically transmissive substrate, the plated substrate 100 can function as a polarizing plate.

3. Electronic Device

FIG. 10 shows an example of an electronic device that uses a plated substrate fabricated by the method for fabricating a plated substrate in accordance with the present embodiment. When the substrate 10 is formed from a dielectric substrate, the plated substrate 100 can function as a wiring substrate. The electronic device 1000 includes the plated substrate 100 as a wiring substrate, an integrated circuit chip 90 and another substrate 92.

Writing patterns formed on the plated substrate 100 may electrically connect electronic components to one another. The plated substrate 100 is fabricated by the above-described fabrication method. In the example shown in FIG. 10, the plated substrate 100 is electrically connected to an integrated circuit chip 90, and one end of the plated substrate 100 is electrically connected to another substrate 92 (for example, a display panel). The electronic device 1000 may be a display device, such as, a liquid crystal display device, a plasma display device, an EL (electro luminescence) display device or the like.

Also, the plated substrate 100 as an optical element substrate may function as a polarizing plate of a liquid crystal display device, a projector device or the like.

Furthermore, the invention may include compositions that are substantially the same as the compositions described in the embodiments (for example, a composition with the same function, method and result, or a composition with the same object and result). Also, the invention includes compositions in which portions not essential in the compositions described in the embodiments are replaced with others. Also, the invention includes compositions that achieve the same functions and effects or achieve the same objects of those of the compositions described in the embodiments. Furthermore, the invention includes compositions that include publicly known technology added to the compositions described in the embodiments.

What is claimed is:

1. A plated substrate comprising:
a substrate;
a resin formed body having a specified pattern including catalytic metal that functions as a catalyst for electroless plating; and
a metal layer formed on a top surface of the resin layer.

2. A plated substrate according to claim 1, wherein the metal layer is formed on a top surface and a side surface of the resin formed body, and the metal layer formed on the top surface of the resin formed body has a film thickness greater than a film thickness of the metal layer formed on the side surface of the resin formed body.

3. A plated substrate according to claim 1, wherein the resin formed body is composed of photoresist.

4. A plated substrate according to claim 1, wherein the substrate is a transparent substrate that transmits light having a predetermined wavelength.

5. A method for fabricating a plated substrate comprising the steps of:
(a) forming on a substrate a resin formed body having a specified pattern including catalytic metal that functions as a catalyst for electroless plating; and
(b) forming a metal layer by dipping the substrate in an electroless plating liquid to precipitate metal on the resin formed body.

6. A method for fabricating a plated substrate according to claim 5, wherein the step (a) includes the steps of:
coating a resin material in a flow condition containing the catalytic metal on the substrate;
pressing a nanostamper having a recessed pattern with a predetermined pattern to the substrate thereby transferring the predetermined pattern to the resin material; and
hardening the resin material.

7. A method for fabricating a plated substrate according to claim 6, wherein, between the step (a) and the step (b), an upper portion of the hardened resin material and a portion of the resin material in a region other than the predetermined pattern are removed by ashing.

8. A method for fabricating a plated substrate according to claim 5, wherein, the resin formed body is composed of photoresist, and the resin formed body is formed by an interference exposure method in the step (a).
